(19) United States
(12) Patent Application Publication
(10) Pub. No.: US 2020/0014002 A1
(43) Pub. Date: Jan. 9, 2020

(54) BATTERY MOUNTING STRUCTURE AND ELECTRONIC DEVICE

(71) Applicant: SZ DJI TECHNOLOGY CO., LTD., Shenzhen (CN)

(72) Inventor: Yanxin HUANG, Shenzhen (CN)

(21) Appl. No.: 16/578,005

(22) Filed: Sep. 20, 2019

Related U.S. Application Data
(63) Continuation of application No. PCT/CN2017/088132, filed on Jun. 13, 2017.

(30) Foreign Application Priority Data
Apr. 20, 2017 (CN) 201720425007.7

(51) Int. Cl. H01M 2/10

(52) U.S. Cl. CPC H01M 2/1066; H01M 2220/30

(57) ABSTRACT

A battery mounting structure for mounting a battery includes a housing. The housing includes a receiving groove configured to receive the battery. The receiving groove includes a groove bottom surface and a groove side wall connected with the groove bottom surface. The housing also includes a receiving space extending through the groove bottom surface and the groove side wall. A first position limiting member is provided on the housing. The first position limiting member is configured to detachably couple with the battery and to restrain the battery to move in a plane perpendicular to the groove bottom surface. The battery mounting structure also includes a second position limiting member provided on the housing. The second position limiting member includes a position limiting block and a button connected with one another and movable together with one another, the button being received in the housing and exposed from the housing.

### CROSS-REFERENCE TO RELATED APPLICATIONS

This application is a continuation application of International Application No. PCT/CN2017/088132, filed on Jun. 13, 2017, which claims priority to Chinese Patent Application No. 201720425007.7, filed on Apr. 20, 2017, the entire contents of both of which are incorporated herein by reference.

### TECHNICAL FIELD

The present disclosure relates to a battery mounting structure and an electronic device including the battery mounting structure.

### BACKGROUND

Currently, electronic devices, such as a typical display device, an ultrabright display device, a cell phone, a pad, etc., all have the same problem of poor battery life. In order to not affect the user experience, an external battery is provided that may engage with a housing of the electronic device and provide electric power to the electronic device to increase the battery run time. If the external battery is used frequently, the electricity may be exhausted, and the external battery may need replacement. However, it is not convenient to detach a currently available external battery that has been mounted to the housing.

### SUMMARY

In accordance with an aspect of the present disclosure, there is provided a battery mounting structure for mounting a battery. The battery mounting structure includes a housing. The housing includes a receiving groove configured to receive the battery. The receiving groove includes a groove bottom surface and a groove side wall connected with the groove bottom surface. The housing also includes a receiving space extending through the groove bottom surface and the groove side wall. The battery mounting structure also includes a first position limiting member provided on the housing. The first position limiting member is configured to detachably couple with the battery and to restrain the battery to move in a plane perpendicular to the groove bottom surface. The battery mounting structure also includes a second position limiting member provided on the housing. The second position limiting member includes a position limiting block and a button connected with one another and movable together with one another. The button is received in the housing and exposed from the housing, and is separately disposed from the receiving groove. The position limiting block extends into the receiving groove from the receiving space, and is configured to snap-fit within a position limiting groove formed at a bottom of the battery to restrain the battery to move in a plane parallel with the groove bottom surface. The button is configured to move, when pressed, to cause the position limiting block to move in the same direction to exit the position limiting groove. The position limiting block exiting the position limiting groove releases the restraint on the battery to move in the plane parallel with the groove bottom surface.

In accordance with another aspect of the present disclosure, there is also provided an electronic device. The electronic device includes a battery and a battery mounting structure. The battery mounting structure includes a housing. The housing includes a receiving groove configured to receive the battery. The receiving groove includes a groove bottom surface and a groove side wall connected with the groove bottom surface. The housing also includes a receiving space extending through the groove bottom surface and the groove side wall. The battery mounting structure also includes a first position limiting member provided on the housing. The first position limiting member is configured to detachably couple with the battery and to restrain the battery to move in a plane perpendicular to the groove bottom surface. The battery mounting structure also includes a second position limiting member provided on the housing. The second position limiting member includes a position limiting block and a button connected with one another and movable together with one another. The button is received in the housing and exposed from the housing, and is separately disposed from the receiving groove. The position limiting block extends into the receiving groove from the receiving space, and is configured to snap-fit within a position limiting groove formed at a bottom of the battery to restrain the battery to move in a plane parallel with the groove bottom surface. The button is configured to move, when pressed, to cause the position limiting block to move in the same direction to exit the position limiting groove. The position limiting block exiting the position limiting groove releases the restraint on the battery to move in the plane parallel with the groove bottom surface.

The electronic device and the battery mounting structure of the present disclosure use a receiving groove to receive a battery, and use a first position limiting member to engage with the batter to limit or restrain the battery to move in a plane perpendicular to a bottom surface of the receiving groove. Further, the electronic device and the battery mounting structure may use a position limiting block to snap-fit in a position limiting groove to thereby limit or restrain the battery move in a plane parallel with a bottom surface of the position limiting groove, which realizes fixing the mounting of the battery. In some embodiments, the electronic device and the battery mounting structure may release the limitation on the battery to move in a plane perpendicular to the bottom surface of the receiving groove by detaching the first position limiting member from the battery. The electronic device and the battery mounting structure may use pressing of a button to cause the position limiting block to move in the same direction until the position limiting block exits the position limiting groove, thereby releasing the limitation or restraint on the battery to move in a plane parallel with the bottom surface of the position limiting groove. As such, the battery is detached conveniently.

The some of the additional features and the advantages of the present disclosure will be reflected in the following descriptions, will be obvious from the following descriptions, or may be learned through actual implementation of the present disclosure.

### BRIEF DESCRIPTION OF THE DRAWINGS

To better describe the technical solutions of the various embodiments of the present disclosure, the accompanying drawings showing the various embodiments will be briefly described. As a person of ordinary skill in the art would appreciate, the drawings show only some embodiments of the present disclosure. Without departing from the scope of the present disclosure, those having ordinary skills in the art could derive other embodiments and drawings based on the disclosed drawings without inventive efforts.

FIG. 1 is a perspective view of a battery mounting structure, according to an example embodiment.

FIG. 2 is a cross-sectional view of a battery, according to an example embodiment.

FIG. 3 is a perspective cross-sectional view of part of the battery mounting structure cut through the line III-III in FIG. 1, according to an example embodiment.

FIG. 4 is an enlarged and perspective view of a portion of the battery mounting structure at location IV in FIG. 3, according to an example embodiment.

FIG. 5 is an enlarged and perspective view of a portion of the battery mounting structure at location V in FIG. 3, according to an example embodiment.

FIG. 6 is a perspective cross-sectional view of part of an electronic device, according to an example embodiment.

FIG. 7 is a cross-sectional view of the electronic device of FIG. 6, according to an example embodiment.

FIG. 8 is a schematic illustration of the principle of detaching the battery from the electronic device of FIG. 6, according to an example embodiment.

### ELEMENTS LIST

| | |
|---|---|
| Electronic device | 1000 |
| Battery mounting structure | 100 |
| Battery | 200 |
| Housing | 10 |
| Receiving groove | 11 |
| Groove bottom surface | 112 |
| Withdrawing space | 1120 |
| Groove side wall | 114 |
| Receiving space | 116 |
| Storage groove | 13 |
| Guiding column | 15 |
| First position limiting member | 20 |
| Extension member | 22 |
| Snap-fit member | 24 |
| Side surface | 242 |
| Second position limiting member | 30 |
| Position limiting block | 32 |
| Connecting rod | 33 |
| Through hole | 330 |
| Button | 34 |
| Depression | 340 |
| Elastic member | 36 |
| Blocking member | 38 |
| Guiding column | 39 |
| Electrical connector | 40 |
| Snap-fit groove | 201 |
| Snap-in chamber | 2012 |
| Snap-fit chamber | 2014 |
| Extension block | 2016 |
| Position limiting groove | 202 |
| Buffer chamber | 2022 |
| Position limiting chamber | 2024 |

The detailed embodiments of the present disclosure will be described with reference to the drawings.

### DETAILED DESCRIPTION OF THE EMBODIMENTS

Technical solutions of the present disclosure will be described in detail with reference to the drawings, in which the same numbers refer to the same or similar elements unless otherwise specified. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

The direction or positional relationship indicated by terms “center,” “longitudinal,” “lateral,” “length,” “width,” “thickness,” “above,” “up,” “below,” “down,” “front,” “rear,” “back,” “left,” “right,” “vertical,” “horizontal,” “top,” “bottom,” “internal,” “external,” “clockwise,” and “counter-clockwise” are based on the direction or positional relationship shown in the figures, and are merely for the convenience of describing the present disclosure and simplifying the descriptions. These terms do not indicate or imply that the device or element referred to must be associated with a specific direction or orientation, or must have a specific directional configuration or operation. Hence, these terms do not limit the scope of the present disclosure. In addition, the terms “first,” “second,” etc., are merely for descriptions purposes and should not be understood to indicate or imply any relative importance level, or any number of technical features. The features modified by “first,” “second” may explicitly or implicitly include one or more such features. In the present disclosure, the term “multiple” means two or more than two, unless expressly defined otherwise.

In the present disclosure, unless there is other express definition, the terms “mount,” “connect,” or “couple” should be interpreted broadly. For example, the connection may be permanent, fixed connection, or may be detachable connection, or integral connection. The connection may be mechanical, electrical, or communicative. The connection may be direct connection, indirect connection through an intermediate medium, connection between internal spaces of two elements, or interactive relationship between two elements. A person having ordinary skills in the art can interpret the meaning of the terms based on specific context.

In the present disclosure, unless there is other express definition, when a first component (feature, element, unit, part, or piece) is disposed above or below a second component, the first and second components may directly contact each other, or the first and second components do not directly contact each other, but rather, indirectly contact each other through another component disposed between the first and second component. When the first component is described as disposed or located “on,” “above,” or “over” the second component, the first component may be disposed or located right above (or “on” or “over”) the second component or may be disposed or located slantly above (or “on” or “over”) the second component, or it may indicate that the horizontal height of the first component is higher than that of the second component. When the first component is described as disposed or located “under,” “below,” or “underneath,” it may indicate that the first component is located or disposed right below (or “under,” “underneath”) the second component or located slantly below (or “under,” “underneath”) the second component, or it may indicate that the horizontal height of the first component is lower than the second component.

The following descriptions provide various implementation methods or examples for implementing different structures disclosed in the present disclosure. To simplify the descriptions, only parts and configurations of specific examples are described. They are for illustration purposes only, and do not limit the scope of the present disclosure. The present disclosure may use the same numbers and/or characters to refer to similar or the same elements for the purposes of simplification and clarity. The same numbers and/or characters do not indicate any particular relationship between different implementation methods and/or configurations. Further, the present disclosure provides examples of various specific processing method and material. A person having ordinary skills in the art can appreciate that other suitable processing methods and materials may also be used.

In addition, the singular forms “a,” “an,” and “the” are intended to include the plural forms as well, unless the context indicates otherwise. And, the terms “comprise,” “comprising,” “include,” and the like specify the presence of stated features, steps, operations, elements, and/or components but do not preclude the presence or addition of one or more other features, steps, operations, elements, components, and/or groups. The term “and/or” used herein includes any suitable combination of one or more related items listed. For example, A and/or B can mean A only, A and B, and B only. The symbol “/” means “or” between the related items separated by the symbol. The phrase “at least one of” A, B, or C encompasses all combinations of A, B, and C, such as A only, B only, C only, A and B, B and C, A and C, and A, B, and C. In this regard, A and/or B can mean at least one of A or B.

Further, when an embodiment illustrated in a drawing shows a single element, it is understood that the embodiment may include a plurality of such elements. Likewise, when an embodiment illustrated in a drawing shows a plurality of such elements, it is understood that the embodiment may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one embodiment but not another embodiment may nevertheless be included in the other embodiment.

The following descriptions explain example embodiments of the present disclosure, with reference to the accompanying drawings. Unless otherwise noted as having an obvious conflict, the embodiments or features included in various embodiments may be combined.

The following embodiments do not limit the sequence of execution of the steps included in the disclosed methods. The sequence of the steps may be any suitable sequence, and certain steps may be repeated.

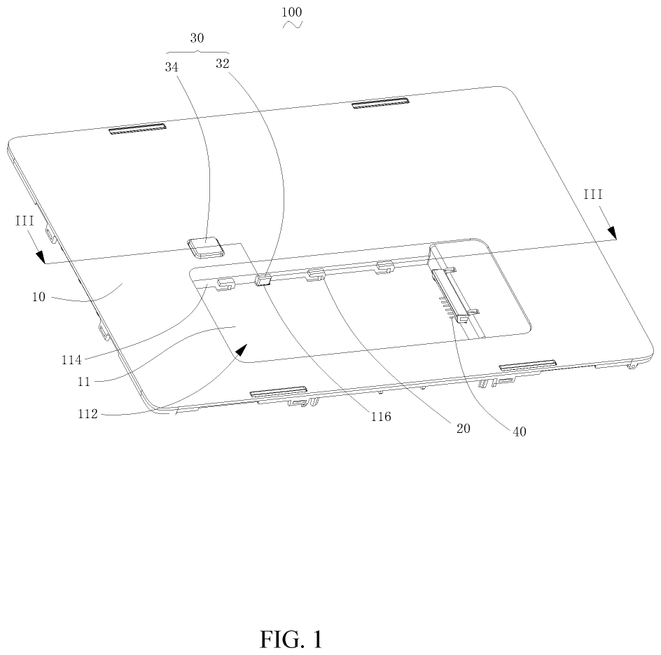

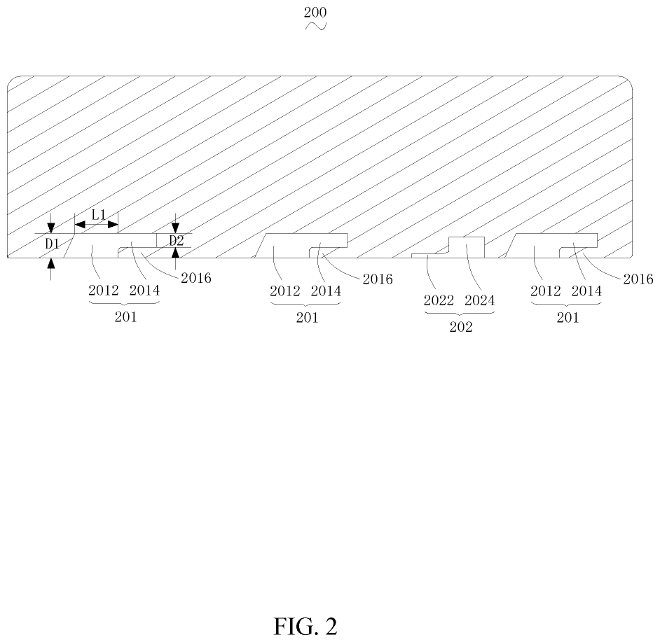

Referring to FIG. 1 and FIG. 2, the present disclosure provides a battery mounting structure 100 configured for mounting a battery 200. A position limiting groove 202 may be formed at a bottom of the battery 200. The battery mounting structure 100 may include a housing 10, a first position limiting member 20 provided (e.g., mounted) on the housing 10, and a second position limiting member 30 provided (e.g., mounted) on the housing 10.

The housing 10 may include a receiving groove 11 configured to receive the battery 200. The receiving groove 11 may include a groove bottom surface 112 and a groove side wall 114 connected with the groove bottom surface 112. The housing may also include a receiving space 116 extending through the groove bottom surface 112 and the groove side wall 114. The first position limiting member 20 and the battery 200 may be detachably coupled together. The first position limiting member 20 may be configured to limit or restrain the battery 200 to move in a plane perpendicular to the groove bottom surface 112. The second position limiting member 30 may include a position limiting block 32 and a button 34 connected with one another and movable together with one another. The button 34 may be received in the housing 10 mand may expose from the housing 10. The button 34 may be separately disposed from the receiving groove 11 (i.e., the button 34 may be located outside of the receiving groove 11). The position limiting block 32 may extend into the receiving groove 11 from the receiving space 116. The position limiting block 32 may snap-fit within the position limiting groove 202 to limit or restrain the battery 200 to move in a plane parallel with the groove bottom surface 112. The button 34 may move when pressed. The movement of the button 34 may cause the position limiting block 32 to move in the same direction to exit the position limiting groove 202, thereby releasing the limitation or the restraint on the battery to move in the plane parallel with the groove bottom surface 112.

The battery mounting structure 100 receive the battery 200 through the receiving groove 11. The first position limiting member 20 may be engaged with the battery 200 to limit or restrain the battery 200 to move in the plane perpendicular to the groove bottom surface 112. The position limiting block 32 may snap-fit within the position limiting groove 202 to limit the battery 200 to move in the plane parallel with the groove bottom surface 112, thereby securely mounting the battery 200. On the other hand, the first position limiting member 20 of the battery mounting structure 100 may be detached from the battery 200 to release the limitation or restraint on the battery 200 to move in the plane perpendicular to the groove bottom surface 112. The button 34 may move when pressed to cause the position limiting block 32 to move in the same direction to exit the position limiting groove 202, thereby releasing the limitation or restraint on the battery 200 to move in the plane parallel with the groove bottom surface 112. As a result, the battery 200 can be conveniently detached from the battery mounting structure 100.

As shown in FIG. 2, the battery 200 may provide an electric power to any suitable electronic devices, such as a display screen, a display device, a tablet, a cell phone, or a remote control device. A bottom side of the battery 200 may be provided with a snap-fit groove 201 and a position limiting groove 202. In some embodiments, the battery may include one position limiting groove 202, and six snap-fit grooves 201. The six snap-fit grooves 201 may be evenly (or uniformly) distributed on two sides of the bottom side of the battery 200. For example, in some embodiments, three snap-fit grooves 201 may be provided at an edge of a side of the bottom of the battery 200 forming a first straight line. Another three snap-fit grooves 201 may be provided at an edge of an opposing side of the bottom of the battery 200 forming a second straight line. The position limiting groove 202 may be provided at the edge of the opposing side of the bottom of the battery 200 and may form the second straight line with the three snap-fit grooves 201.

Each snap-fit groove 201 may be formed by an inward depression of a surface of the bottom of the battery 20 that contacts the groove bottom surface 112. The snap-fit groove 201 may have a substantially inverted “L” shape. The snap-fit groove 201 may include a snap-in chamber 2012 and a snap-fit chamber 2014 that are connected with one another. The depth D1 of the snap-in chamber 2012 may be greater than the depth D2 of the snap-fit chamber 2014. The snap-fit chamber 2014 and the bottom of the battery may form an extension block 2016.

The position limiting groove 202 may be formed by an inward depression of a surface of the bottom of the battery 200 that contacts the groove bottom surface 112. The position limiting groove 202 may have a stepped shape. The position limiting grove 202 may include a buffer chamber 2022 and a position limiting chamber 2024 that are connected with one another. The depth of the buffer chamber 2022 may be smaller than the depth of the position limiting chamber 2024.

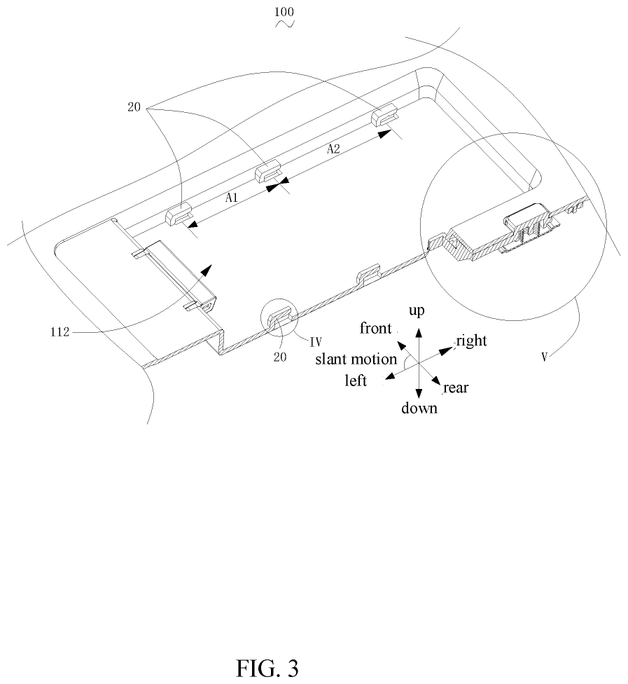

As shown in FIG. 3, the first position limiting member 20 may fit with the snap-fit groove 201, including at least a matching quantity, shape, distribution fashion, and size. The first position limiting member 20 may be a snap-fit mechanism provided on the groove bottom surface 112 configured to snap-fit within the snap-fit groove 201 to limit or restrain the battery 200 to move in the plane perpendicular to the groove bottom surface 112. In some embodiments, the quantity of the first position limiting member 20 may be six, which may be evenly distributed on two sides of the groove bottom surface 112. For example, three first position limiting members 20 may be provided at an edge of a side of the groove bottom surface 112 (i.e., three first position limiting members 20 may be disposed adjacent a groove side wall 114) forming a third straight line. Another three first position limiting members 20 may be provided at an edge of an opposing side of the groove bottom surface 112 (i.e., the other three first position limiting members 20 may be disposed adjacent an opposing groove side wall 114) in a fourth straight line. The third straight line may coincide with the first straight line, and the fourth straight line may coincide with the second straight line.

Referring to FIG. 2 to FIG. 4, the first position limiting member 20 may have a substantially inverted “L” shape. Each first position limiting member 20 may include an extension member 22 extending from the groove bottom surface 112 and a snap-fit member 24 bending and extending from the extension member 22. The extension member 22 may be substantially perpendicular to the groove bottom surface 112. The snap-fit member 24 may be substantially parallel with the groove bottom surface 112. An end of the snap-fit member 24 may be connected with the extension member 22, and another end of the snap-fit member 24 may be a free end. The first position limiting member 20 matching with the snap-fit groove 201 in size may refer to: a length L1 of the snap-in chamber 2012 is greater than or equal to a length L2 of the snap-fit member 24, a depth D1 of the snap-in chamber 2012 is greater than or equal to a height H1 of the snap-fit member 24, such that the first position limiting member 20 may enter into the snap-fit groove 201 from the snap-in chamber 2012. A depth D2 of the snap-fit chamber 2014 may be greater than or equal to a thickness T1 of the snap-fit member 24 such that the snap-fit member 24 may be received in the snap-fit chamber 2014 and may abut against the extension block 2016.

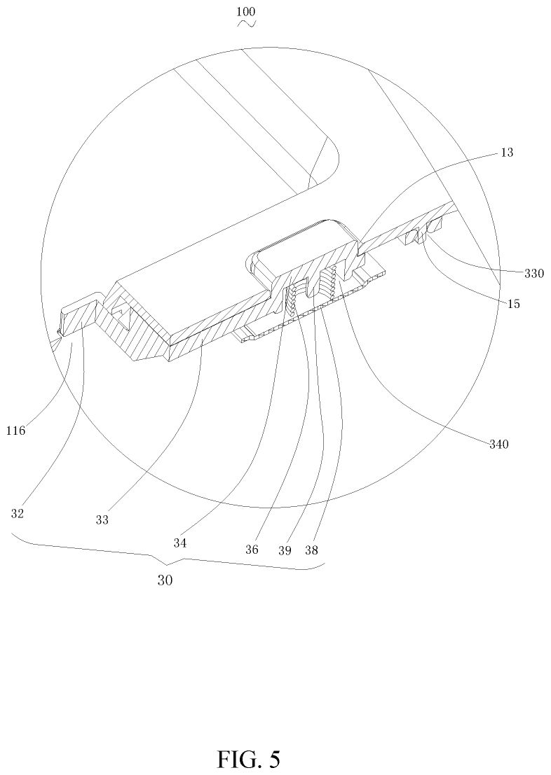

As shown in FIG. 1 and FIG. 5, in some embodiments, the battery mounting structure 100 may include an electrical connector 40 configured to plug-in with the battery 200 to realize electrical connections. The electrical connector 40 may extend into the receiving groove 11 from the groove side wall 114, and may be located between the third straight line and the fourth straight line. The housing 10 may include a storage groove 13 separately provided from the receiving groove 11. The housing 10 may further include a guiding column 15 disposed inside the housing 10. The second position limiting member 30 may include a connecting rod 33, an elastic member 36, and a blocking member 38. The position limiting block 32 may be disposed at an end of the connecting rod 33. The other end of the connecting rod 33 may be provided with a through hole 330. The button 34 may be disposed on the connecting rod 33 and may be disposed between the through hole 330 and the position limiting block 32. The connecting rod 33, the elastic member 36, and the blocking member 38 may be disposed inside the housing 10. The button 34 may be disposed extending throughout the storage groove 13. The button 34 and the blocking member 38 may be disposed opposing each other. The two ends of the elastic member 36 may abut against the button 34 and the blocking member 38, respectively. The guiding column 15 may be disposed extending within the through hole 330. In some embodiments, the elastic member 36 may include a spring.

To better understand that the battery mounting structure 100 may detachably mount the battery 200, the mounting and the detaching processes of the battery 200 are described below.

The battery 200 may be mounted and fixed to the battery mounting structure 100 using the following processes:

Referring to FIG. 3 and FIGS. 5-7, first, the battery 200 may be placed in the receiving groove 11. The snap-fit member 24 may be received in the snap-in chamber 2012. The position limiting block 32 may be located in the buffer chamber 2022 and may abut against a bottom surface of the buffer chamber 2022.

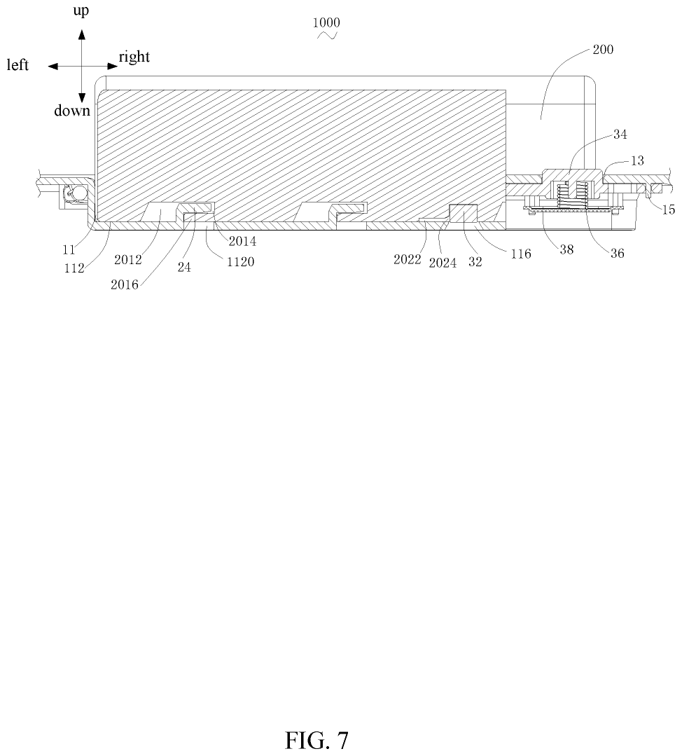

Then, the battery 200 may be pressed. In the meantime, the battery 200 may be pushed in a direction (on the left side in FIG. 3) approaching the electrical connector 40, until the snap-fit member 24 of the first position limiting member 20 is completely received in the snap-fit chamber 2014 and abuts against the extension block 2016, and until the position limiting block 32 moves from the buffer chamber 2022 into the position limiting chamber 2024. In this process, initially, the position limiting block 32 may move in a direction away from the receiving groove 11 (i.e., downward moving from the perspective of FIG. 3 and FIG. 7) under the pressing of the battery 200, causing the button 34 to move into the inside of the housing 10 and press the elastic member 36 to compress the elastic member 36. After the position limiting block 32 completely enters into the position limiting chamber 2024 from the buffer chamber 2022, the elastic member 36 restores its shape, and the button 34 moves toward an outside of the housing 10 under the resilient force of the elastic member 36, thereby exposing from the storage groove 13. The height of the position limiting block 32 may be greater than the depth of the buffer chamber 2022. The height of the position limiting block 32 may match with the depth of the position limiting chamber 2024. At this moment, the battery 200 is plugged into the electrical connector 40 to form an electrical connection. The bottom of the battery 200 rests on the groove bottom surface 112. The snap-fitting between the snap-fit member 24 and the snap-fit chamber 2014 may limit or restrain the battery 200 to move in the plane perpendicular to the groove bottom surface 112. The snap-fitting between the position limiting block 32 and the position limiting chamber 2024 may limit or restrain the battery 200 to move in the plane parallel with the groove bottom surface 112, thereby securely mounting the battery 200 to the receiving groove 11 of the battery mounting structure 100. In this process, the second position limiting member 30 may form a lever using the guiding column 15 as a supporting point. Due to the function of the lever, the fitting distance between the position limiting block 32 and the battery 200 is long, which may help securely limit or restrain the movement of the battery 200.

In some embodiments, the movement of the battery 200 in the plane perpendicular to the groove bottom surface 112 may not only include the up and down movement of the battery (from the perspective of FIG. 3 and FIG. 7), but also include the slantly upward movement and slantly downward movement in any angle. The movement of the battery 200 in the plane parallel with the groove bottom surface 112 may not only include the left-right and front-rear movements of the battery in the receiving groove 11 (from the perspective of FIG. 3 and FIG. 7), but also include a slant motion (or movement) in any angle in the plane parallel with the groove bottom surface 112.

The battery 200 may be detached from the battery mounting structure 100 using the following processes:

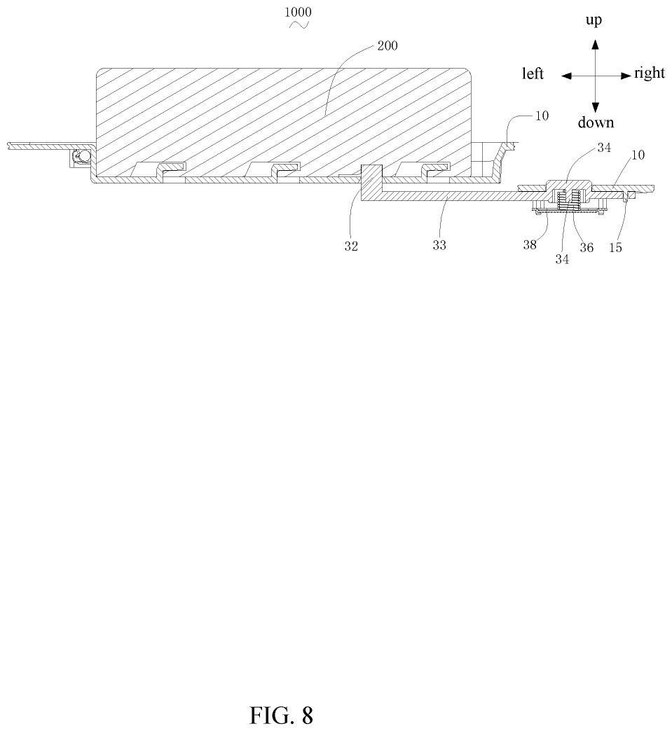

Referring to FIG. 3 and FIGS. 5-7, first the button 34 is pressed to move into the inside of the housing (downward movement) to press the elastic member 36. The position limiting block 32 may move downwardly together with the button 34 until existing the position limiting chamber 2024. At this moment, the limitation or restraint of position limiting block 32 on the battery 200, which limits or restrains the battery 200 to move in the plane parallel with the groove bottom surface 112, is released. Referring to FIG. 8, FIG. 8 does not show the actual effect. Rather, FIG. 8 only schematically shows the principle of detaching the battery 200 from the battery mounting structure 100. In this process, the second position limiting member 30 may form a lever using the guiding column 15 as a supporting point. When the button 34 is pressed, due to the function of the lever, the short moving distance of the button 34 may cause the position limiting block 32 to move a relatively large distance, which makes it convenient to release the limitation or restraint on the battery 200.

Then, at the same time while the button 34 is continuously pressed, the battery 200 is pushed in a direction (to the right as shown in the figure) moving away from the electrical connector 40 until the snap-fit member 24 of the first position limiting member 20 exits into the snap-in chamber 2012 from the snap-fit chamber 2014. At this moment, the limitation or restraint of the snap-fit member 24 on the battery, which limits or restrains the battery 20 to move in the plane perpendicular to the groove bottom surface 112, is released.

Finally, the battery 200 may be removed out of the receiving groove 11 by lifting up the battery 200 from the receiving groove 11. The pressing on the button 34 is released, and the elastic member 36 restores its shape. The button 34 may move outside of the housing 10 (the upward movement shown in the figure) under the resilient force of the elastic member 36 so as to expose from the storage groove 13, which causes the position limiting block 32 to move upwardly to again extend into the receiving groove 11 from the receiving space 116.

According to the present disclosure, the battery 200 may be received in the receiving groove 11 of the battery mounting structure 100. The snap-fit member 24 of the first position limiting member 20 and the snap-fit chamber 2014 may snap-fit together to limit or restrain the battery 200 to move in the plane perpendicular to the groove bottom surface 112. In the meantime, the position limiting block 32 and the position limiting chamber 2024 may snap-fit together to limit the battery 200 to move in the plane parallel with the groove bottom surface 112, thereby achieving the secure mounting of the battery 200. On the other hand, in the battery mounting structure 100, the snap-fit member 24 of the first position limiting member 20 may exit from the snap-fit chamber 2014 to release the limitation or restraint on the battery 200, which limits or restrains the battery 200 to move in the plane perpendicular to the groove bottom surface 112. Also, in the battery mounting structure 100, the button 34 may be pressed to cause the position limiting block 32 to move in the same direction to exit the position limiting groove 202, thereby releasing the limitation or restraint on the battery 200, which limits or restrains the battery 200 to move in the plane parallel with the groove bottom surface 112. As a result, with the battery mounting structure 100, the battery can be conveniently detached.

In some embodiments, the quantity of the snap-fit grooves 201 is not limited to be six. Rather, the quantity of the snap-fit grooves 201 may be any suitable number, such as two, three, four, five, seven, etc. The distribution of the snap-fit grooves 201 is not limited to the even or uniform distribution on two sides of the bottom of the battery 200. The distribution of the snap-fit grooves 201 may be uneven or non-uniform. For example, when there are three snap-fit grooves 201, one snap-fit groove 201 may be provided at an edge of one side of the bottom of the battery 200, and two snap-fit grooves 201 may be provided at an edge of the other side of the bottom of the battery 200. When there are six snap-fit grooves 201, two snap-fit grooves 201 may be provided at an edge of one side of the bottom of the battery 200, and four snap-fit grooves 201 may be provided at an edge of the other side of the bottom of the battery 200. Correspondingly, the quantity of the first position limiting members 20 may not be limited to six. Rather, the quantity of the first position limiting members 20 may be any suitable number, such as two, three, four, five, seven, etc. The distribution of the first position limiting members 20 is not limited to even distribution on two sides of the groove bottom surface 112. The distribution of the first position limiting members 20 may be uneven or non-uniform. For example, when there are three first position limiting members 20, one first position limiting member 20 may be provided at an edge of one side of the groove bottom surface 112, and two first position limiting members 20 may be provided at an edge of the other side of the groove bottom surface 112. When there are six first position limiting members 20, two first position limiting members 20 may be provided at an edge of one side of the groove bottom surface 112, and four first position limiting members 20 may be provided at an edge of the other side of the groove bottom surface 112.

In some embodiments, the elastic member 36 may include at least one of an elastic plate, an elastic tube, or a rubber, etc.

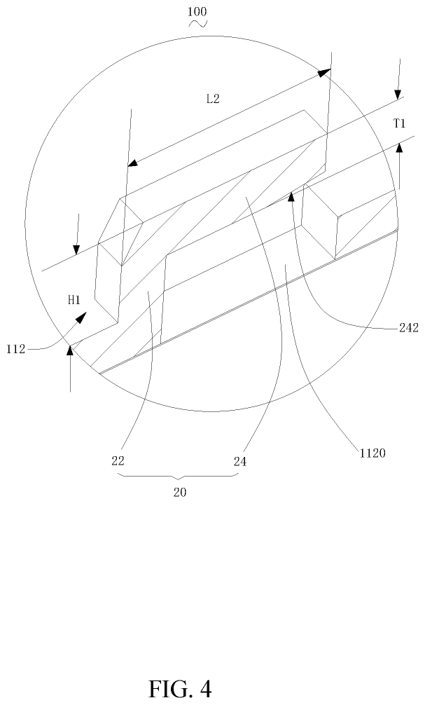

As shown in FIG. 4, in some embodiments, the free end of the snap-fit member 24 faces a side surface 242 of the groove bottom surface 112 in a predetermined slant angle relative to the groove bottom surface 112. The thickness of the snap-fit member 24 is not uniformly provided. For example, the thickness of the snap-fit member 24 at the free end may be slightly smaller than the thickness of the end of the snap-fit member 24 connected with the extension member 22. As such, the smoothness of the sliding engagement between the snap-fit 24 and the snap-fit chamber 2014 may be maintained as the snap-fit member 24 snap-into the snap-fit chamber 2014, which makes the mounting easy and convenient.

As shown in FIG. 3, in some embodiments, the first position limiting member 20 may include a mistake-proofing design, which may avoid the battery 200 being mounted in an incorrect direction. For example, in some embodiments, the distances A1 and A2 between two adjacent first position limiting members among the three position limiting members 20 on the third straight line are different. Correspondingly, the two distances (not shown in figure) between two adjacent first position limiting members 20 among the three position limiting members 20 on the fourth straight line are different.

As shown in FIG. 5, in some embodiments, the second position limiting member 30 may include a guiding column 39 extending from the button 34 toward the blocking member 38. The elastic member 36 may be sleeve fit onto the guiding column 39. The guiding column 39 may increase the stability of the elastic member 36, such that the elastic member 36 is restrained from jumping out.

As shown in FIG. 5, in some embodiments, a depression 340 may be formed on a surface of the button 34 facing the blocking member 38. The elastic member 36 may be partially received in the depression 340. The depression 340 may increase the stability of the elastic member 36, restraining the elastic member 36 from jumping out. With the depression 340 provided on the button 34, and the second position limiting member 30 including the guiding column 39 extending from the button 34 toward the blocking member 38, when the elastic member 36 is sleeve fit onto the guiding column 39, the stability of the elastic member 36 is further improved, thereby further restraining the elastic member 36 from jumping out.

Further, in some embodiments, two ends of the elastic member 36 may abut against the blocking member 38 but not fixedly connect with the blocking member 38; or an end of the elastic member 36 may be fixedly connected with the button 34, and the other end of the elastic member 36 may abut against the blocking member 38 but not fixedly connect with the blocking member 38; or an end of the elastic member 36 abuts against the button 34 but not fixedly connect with the button 34, and the other end of the elastic member 36 is fixedly connected with the blocking member 38; or an end of the elastic member 36 is fixedly connected with the button 34, and the other end of the elastic member 36 is fixedly connected with the blocking member 38.

As shown in FIG. 4, in some embodiments, the groove bottom surface 112 may include a withdrawing space 1120 corresponding to the first position limiting member 20. The extension member 22 of the first position limiting member 20 is disposed surrounding the withdrawing space 1120. The snap-fit member 24 of the first position limiting member 20 is disposed opposing the corresponding withdrawing space 1120 to cover the withdrawing space 1120. The withdrawing space 1120 may be a through hole or may be a concave groove. When the battery 200 is mounted to the battery mounting structure 100 and when the battery 200 is detached from the battery mounting structure 100, the battery 200 may move up and down and/or left and right. During the movement, the battery 200 may touch the housing 10. In particular, before the battery 200 is completely snap-fit with the battery mounting structure 100, the extension block 2016 may scratch with the snap-fit member 24. The withdrawing space 1120 may allow the extension block 2016 to partially enter the withdrawing space 1120 to avoid the scratching with the snap-fit member 24 before the extension block 2016 is completely snap-fit with the snap-fit member 24, thereby prolonging the operation life of the battery mounting structure 100.

Referring to FIG. 1 and FIG. 5, in some embodiments, the housing 10 may not include the guiding column 15 that is shown the figures as being disposed inside the housing 10. Correspondingly, the other end of the connecting rod 33 may not include the through hole 330. In other words, the second position limiting member 30 may only include the position limiting block 32, the connecting rod 33, the button 34, the elastic member 36, and the blocking member 38. The position limiting block 32 may be disposed at an end of the connecting rod 33, and the button 34 may be disposed at the other end of the connecting rod 33. The connecting rod 33, the elastic member 36, and the blocking member 38 may be disposed inside the housing 10. The button 34 may be disposed in the storage groove 13. The button 34 may be separated from the blocking member 38 and they may face each other. The two ends of the elastic member 36 may abut against the button 34 and the blocking member 38, respectively. In some embodiments, the elastic member 36 may include a spring.

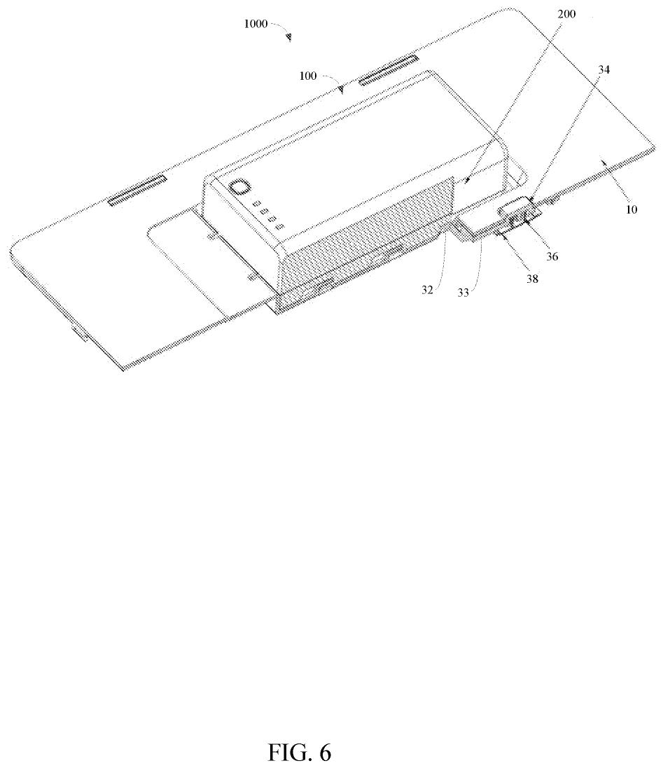

Referring to FIG. 6 and FIG. 7, the electronic device 1000 of the present disclosure may include the battery mounting structure 100 and the battery 200. The battery mounting structure 100 may have any of the embodiments described above regarding the battery mounting structure 100. The battery 200 may be detachably mounted to the battery mounting structure 100. The mounting and detaching of the battery 200 have been described above. The electronic device 1000 may be, but not be limited to, a display screen, a display device, a tablet, a cell phone, and a remote control device, etc. The battery 200 may be an external battery that may provide an electric power to the electronic device 1000.

In the electronic device 1000, the battery mounting structure 100 may receive the battery 200 in the receiving groove 11. The snap-fitting between the snap-fit member 24 of the first position limiting member 20 and the snap-fit chamber 2014 may restrain the battery 200 to move in a plane perpendicular to the groove bottom surface 112. In the meantime, the snap-fitting between the position limiting block 32 and the position limiting chamber 2024 may restrain the battery 200 to move in a plane parallel with the groove bottom surface 112, thereby securing the mounting of the battery 200. On the other hand, in the battery mounting structure 100, when the snap-fit member 24 of the first position limiting member 20 exits from the snap-fit chamber 2014, the limitation or restraint on the battery 200 to move in the plane perpendicular to the groove bottom surface 112 may be released. When the button 34 is pressed to cause the position limiting block 32 to move in the same direction and exit the position limiting groove 202, the limitation or restraint on the battery 200 to move in the plane parallel with the groove bottom surface 112 may be released. Thus, with the disclosed battery mounting structure 100, the battery 200 is easy and convenient to detach or disassemble from the battery mounting structure 100.

A person having ordinary skill in the art can appreciate that when the description mentions “certain embodiments,” “an embodiment,” “some embodiments,” “an example,” “a specific example,” or “some examples,” it means that characteristics, structures, or features related to the embodiment or example are included in at least one embodiment or example of the present disclosure. Thus, when the description uses “in an embodiment” or “in an example” or similar terms, it does not necessarily mean the same embodiment. Various characteristics, structures, or features of various embodiments may be combined in a suitable manner. Various characteristics, structures, or features of one embodiment may be incorporated in another embodiment.

It should be understood that in the present disclosure, relational terms such as first and second, etc., are used for description purposes only, and do not necessarily imply or indicate the relative importance or implicitly indicate the number or quantity of the technical features. Therefore, a “first” or “second” feature may include, explicitly or implicitly, one or more such features. The term “multiple” means at least two, such as two or three, unless otherwise specifically defined.

Other embodiments of the present disclosure will be apparent to those skilled in the art from consideration of the specification and practice of the embodiments disclosed herein. It is intended that the specification and examples be considered as example only and not to limit the scope of the present disclosure, with a true scope and spirit of the invention being indicated by the following claims. Variations or equivalents derived from the disclosed embodiments also fall within the scope of the present disclosure.

What is claimed is:

1. A battery mounting structure for mounting a battery, comprising:
a housing comprising:
a receiving groove configured to receive the battery, the receiving groove comprising a groove bottom surface and a groove side wall connected with the groove bottom surface; and
a receiving space extending through the groove bottom surface and the groove side wall;
a first position limiting member provided on the housing, the first position limiting member configured to detachably couple with the battery and to restrain the battery to move in a plane perpendicular to the groove bottom surface; and
a second position limiting member provided on the housing, the second position limiting member comprising:
a position limiting block and a button connected with one another and movable together with one another,
wherein the button is received in the housing and exposed from the housing, and is separately disposed from the receiving groove,
wherein the position limiting block extends into the receiving groove from the receiving space, and is configured to snap-fit within a position limiting groove formed at a bottom of the battery to restrain the battery to move in a plane parallel with the groove bottom surface,
wherein the button is configured to move, when pressed, to cause the position limiting block to move in the same direction to exit the position limiting groove, and
wherein the position limiting block exiting the position limiting groove releases the restraint on the battery to move in the plane parallel with the groove bottom surface.

2. The battery mounting structure of claim 1,
wherein the housing comprises a storage groove separately disposed from the receiving groove,
wherein the second position limiting member comprises a connecting rod, an elastic member, and a blocking member, and the connecting rod, the elastic member, and the blocking member are disposed inside the housing,
wherein the position limiting block and the button are disposed at two opposing ends of the connecting rod, the button and the blocking member are separately disposed opposing one another, and the two opposing ends of the elastic member are configured to abut against the button and the blocking member, respectively, and
wherein the button is disposed extending throughout the storage groove.

3. The battery mounting structure of claim 1,
wherein the housing comprises a storage groove separately disposed from the receiving groove, and a guiding column disposed inside the housing,
wherein the second position limiting member comprises a connecting rod, an elastic member, and a blocking member disposed inside the housing,
wherein the position limiting block is disposed at an end of the connecting rod, and the other end of the connecting rod is provided with a through hole, the button is disposed on the connecting rod and is located between the through hole and the position limiting member,
wherein the button is disposed in the storage groove,
wherein the button and the blocking member are separately disposed opposing one another, two ends of the elastic member are configured to abut against the button and the blocking member, respectively, and
wherein the guiding column is disposed extending in the through hole.

4. The battery mounting structure of claim 2, wherein the second position limiting member comprises a guiding column extending from the button toward the blocking member, and the elastic member is sleeve-fit on the guiding column.

5. The battery mounting structure of claim 2, wherein the button comprises a depression on a surface facing the blocking member, and the elastic member is partially received in the depression.

6. The battery mounting structure of claim 2, wherein the elastic member comprises at least one of a spring, an elastic plate, an elastic tube, or a rubber.

7. The battery mounting structure of claim 1, wherein the first position limiting member is a snap-fit mechanism provided on the groove bottom surface and configured to snap-fit with a snap-fit groove formed at a bottom of the battery to restrain the battery to move in the plane perpendicular with the groove bottom surface.

8. The battery mounting structure of claim 7,
wherein the snap-fit groove includes a snap-in chamber and a snap-fit chamber that are connected with one another, the snap-fit chamber and the bottom of the battery form an extension block,
wherein the first position limiting member comprises an extension member extending from the groove bottom surface and a snap-fit member bending and extending from the extension member,
wherein the first position limiting member is configured to enter into the snap-fit groove from the snap-in chamber, and
wherein when the first position limiting member couples with the battery, the snap-fit member is received in the snap-fit chamber and abuts against the extension member.

9. The battery mounting structure of claim 8,
wherein the groove bottom surface comprises a withdrawing space corresponding to the first position limiting member,
wherein the extension member of the first position limiting member is disposed surrounding the withdrawing space, and
wherein the snap-fit member of the first position limiting member is disposed opposing the withdrawing space and covering the withdrawing space.

10. The battery mounting structure of claim 8, wherein the withdrawing space is a through hole or a concave groove.

11. An electronic device, comprising:
a battery; and
a battery mounting structure for mounting the battery, the battery mounting structure comprising:
a housing comprising:
a receiving groove configured to receive the battery, the receiving groove comprising a groove bottom surface and a groove side wall connected with the groove bottom surface; and
a receiving space extending through the groove bottom surface and the groove side wall;
a first position limiting member provided on the housing, the first position limiting member configured to detachably couple with the battery and to restrain the battery to move in a plane perpendicular to the groove bottom surface; and
a second position limiting member provided on the housing, the second position limiting member comprising:
a position limiting block and a button connected with one another and movable together with one another,
wherein the button is received in the housing and exposed from the housing, and is separately disposed from the receiving groove,
wherein the position limiting block extends into the receiving groove from the receiving space, and is configured to snap-fit within a position limiting groove formed at a bottom of the battery to restrain the battery to move in a plane parallel with the groove bottom surface,
wherein the button is configured to move, when pressed, to cause the position limiting block to move in the same direction to exit the position limiting groove, and
wherein the position limiting block exiting the position limiting groove releases the restraint on the battery to move in the plane parallel with the groove bottom surface.

12. The electronic device of claim 11, wherein the electronic device comprises at least one of a display screen, a display device, a tablet, a cell phone, or a remote control device.
